(19) United States
(12) Patent Application Publication
(10) Pub. No.: US 2014/0229181 A1
(43) Pub. Date: Aug. 14, 2014

(54) Method and System to Identify Human Characteristics Using Speech Acoustics

(71) Applicant: Daniel Begel, Pacific Palisades, CA (US)

(72) Inventor: Daniel Begel, Pacific Palisades, CA (US)

(21) Appl. No.: 14/178,290

(22) Filed: Feb. 12, 2014

Related U.S. Application Data
(60) Provisional application No. 61/763,663, filed on Feb. 12, 2013.

(51) Int. Cl. G10L 25/48

(52) U.S. Cl. CPC G10L 25/48
USPC 704/270

(57) ABSTRACT

The invention that is described herein identifies human characteristics by means of speech acoustics. It identifies and measures acoustic transformational structures that are contained in speech and determines the best fit between these structures and classified behaviors. It also determines the best fit between the structures of unclassified speech and the structures of speech previously classified as representing a human characteristic, in order to discern the presence of that characteristic in the human token associated with the unclassified speech sample. The invention is useful for identifying a wide variety of cognitive, emotional, linguistic, behavioral, and existential human characteristics.

### CROSS REFERENCE TO RELATED APPLICATION

This application claims priority to U.S. Provisional Patent Application No. 61/763,663, filed Feb. 12, 2013, entitled “Method and System to Identify Human Characteristics Using Speech Acoustics,” naming Dan Begel as inventor.

### BACKGROUND

Speech is know to contain information about how a person thinks, feels, and behaves. This information is broad in scope, applying to an array of behavioral characteristics both known and unknown. For this reason, efforts have been made to identify human characteristics via speech acoustics.

Existing methods typically measure a heterogeneous collection of acoustic variables that are suspected of bearing a relationship to human characteristics such as personality styles, emotions, and so on, and determining the concordance of these measurements with characteristics of people from who the speech derived. (e.g. U.S. Pat. No. 8,195,460, Degani, et. al, Jun. 5, 2012). This is a logical approach that is not without utility. The shortcoming of this approach, however, is that the measured variables do not bear any relationship to the mental activity employed by the speaker in generating speech, and this limits the specificity of its findings. To use an analogy, water on the ground may tell you that it is raining, but for a fuller understanding one must consider the dynamics and structure of the weather system itself.

A better link between speech and human attributes can be determined by measuring the “transformational structures” that people employ in all aspects of their mental life, including speech. These structures are systems for manipulating multiple elements of thought simultaneously, and they are real. As Piaget has said, “The discovery of structure may, either immediately or at a much later stage, give rise to formalization. Such formalization is, however, always the creature of the theoretician, whereas structure itself exists apart from him.” (J. Piaget, Structuralism, Basic Books, 1970, pp. 5). In the realm of speech acoustics, transformational structures were identified by Roman Jakobson (R. Jakobson, Studies on Child Language and Aphasia, Mouton, 1971, pp. 7, 12, 20).

U.S. Pat. No. 8,155,967 (Begel, Apr. 10, 2012) describes an invention for identifying acoustic transformational structures in speech. What is needed is a method and system for identifying human characteristics by reference to their corresponding acoustic transformational structures.

### BRIEF SUMMARY OF THE INVENTION

The invention is a method and system for identifying human characteristics based on acoustic transformational structures contained in speech. It is also a non-transitory computer readable medium containing instructions for implementing the method and system.

Using the invention, a digitized utterance is processed using an appropriate acoustic transformational structure indentifying method or system. The structures identified by the identifier are retained as data by the invention.

Independently of structure identification, a token of human behavior associated with a digitized utterance is classified as containing or representing a human characteristic. Usually, this characteristic will be a characteristic of the speaker who is the source of the utterance. The classification may be an emotional, cognitive, or behavioral characteristic, such as “a mellow personality,” “a deep depression,” or “an intuitive style,” but it may even be a specific item of a class, such as the characteristic of being “the human being who is John Doe, born Nov. 25, 1995 in Columbus, Ohio.” Possible classifications are limited only by the interest of the user of the invention. It is not necessary that the classified human charcteristic be always associated with the speaker who is the source of the digitized utterance, however. In cases where the human characteristic of interest is a listener response, as, for example, in a study of speech that induces fear in others, the classified human characteristic and the associated digitized utterance have their source in the same event but are located in different persons. It is only important the the utterance be associated with the classified token of human behavior in some way.

A variety of techniques for determining the best fit between the acoustic transformational structures and the classified token of human behavior may be employed in various embodiments of the invention. Since acoustic transformational structure identifying systems can identify a host of structures within a speech sample, determining which structures best fit the classified token and in what way depends on the fitting procedure employed. In some embodiments, commercially available software will be used to execute statistical estimations of best fit. In other embodiments, appropriate algorithms may be designed by persons skilled in the art. Still other embodiments may use non-mathematical means, such as visual estimates of best fit or estimates based on procedures as yet unknown.

The invention compares the structures of speech associated with unclassified behavior with the structures of speech associated with behavior classified as representing some human characteristic in order to identify the degree to which the unclassified behavior contains the classified characteristic. The invention admits of the same range of embodiments for determining the best acoustical fit between the structures of unclassified and classified speech as it does for determining the best fit between the structures of a digitized speech sample and its classified characteristic.

The invention includes a non-transitory computer readable media with instructions for executing the above method and system.

### BRIEF DESCRIPTION OF THE DRAWINGS

The invention is described below with reference to the accompanying drawings. The drawings are intended to provide a succinct and readily understood schematic account of the invention. In this regard, no attempt is made to show structural or procedural details in more detail than is necessary for a fundamental understanding of the elements of the invention. The detailed description taken in conjunction with the drawings will make apparent to those persons of ordinary skill in the art how the invention may be embodied in practice.

FIG. 1. A schematic diagram of the software architecture of the invention.

FIG. 2. A flowchart showing the steps for determining the best fit of acoustic transformational structures with a classified token of human behavior.

FIG. 3. A flowchart showing the steps for determining the best fit of unclassified with classfied acoustic transformational structures.

FIG. 4. A schematic diagram of the hardware architecture of the invention.

### DETAILED DESCRIPTION OF THE INVENTION

The invention is a method and system for identifying human characteristics based on acoustic transformational structures contained in speech. It is also a non-transitory computer readable medium containing instructions for implementing the method and system.

It should be appreciated that the present invention can be implemented in numerous ways, including as a process, an apparatus, a system, or a non-transitory computer readable medium such as a computer readable storage medium or a computer network wherein program instructions are sent over optical or electronic communication links. It should be noted that the described order of the steps of the disclosed method and system may be altered within the scope of the invention. The embodiments described below are to be understood as examples only, and are not to be construed as limiting the potential embodiments or applications of the invention, nor as narrowing the scope of CLAIMS.

In addition, the specific terminology used in this specification is for descriptive purposes only, and shall not be construed as excluding from the scope of this invention similar methods and systems described by different terms. Citation of specific software programs or hardware devices employed in the embodiments of the invention shall not be construed as excluding from the scope of the invention software programs, hardware devices, or any other technical means that a person skilled in the art may find appropriate for fulfilling the functions of the invention.

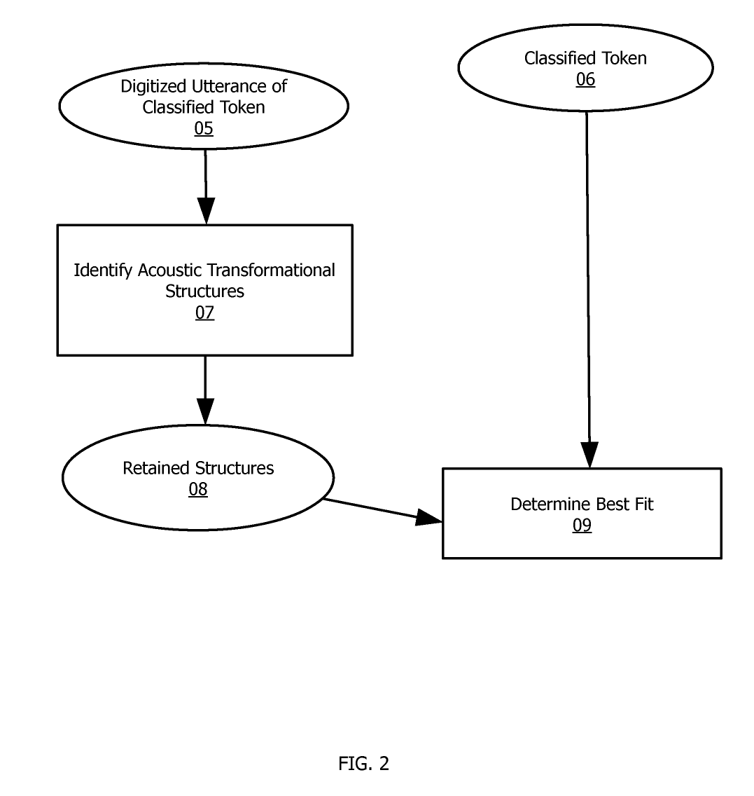

The invention contains two series of steps. In the first series, depicted schematically in FIG. 2, a digitized utterance, FIG. 2 ELEMENT 05, that is associated with a token of human behavior that has been classified as containing or representing a specified characteristic or characterisitcs, FIG. 2 ELEMENT 06, is processed by an acoustic transformational structure identifier, FIG. 2 STEP 07, and the structures so identified and retained, FIG. 2 ELEMENT 08, are assessed for their best fit with the classified token, FIG. 2 STEP 09. The best fitting structures are then considered to signify the presence of the classified characteristic or characteristics.

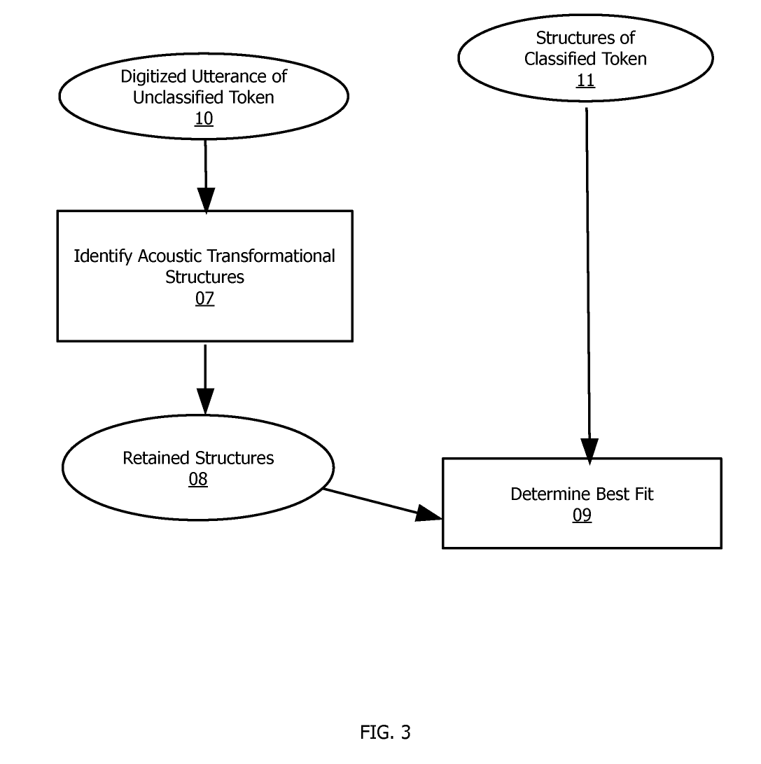

In the second series of steps, depicted schematically in FIG. 3, a digitized utterance associated with an unclassified token of human behavior, FIG. 3 ELEMENT 10, is processed by an acoustic transformational structure identifier, FIG. 3 STEP 07, and the structures so identified and retained, FIG. 3 ELEMENT 08, are assessed for their best fit, FIG. 3 STEP 09, to acoustic transformational structures previously known to fit a token of human behavior classified as containing or representing a specified characteristic or characteristics, FIG. 3 ELEMENT 11. The unclassified token of human behavior is then considered to contain or represent the same specified characteristic or characteristics of the classified token.

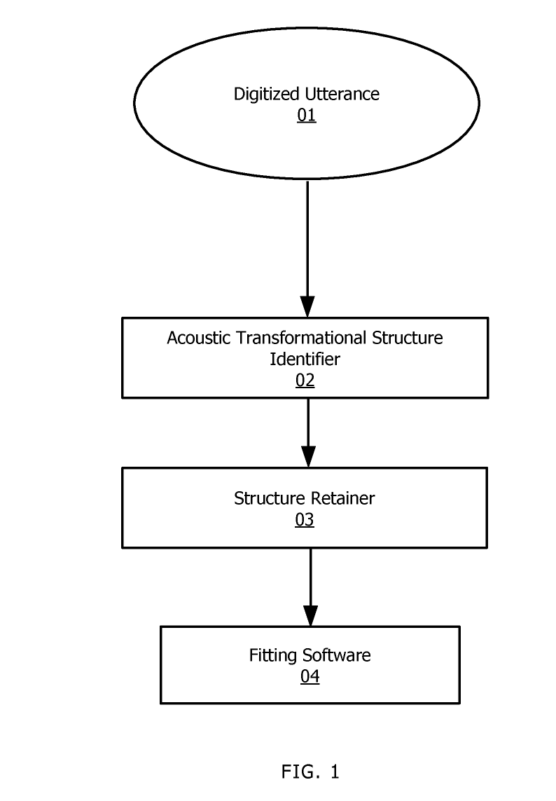

The sequence of software elements in the invention is diagrammed schematically in FIG. 1.

The digitized utterance, FIG. 1 ELEMENT 01, is processed by the acoustic transformational structure identifier, FIG. 1 ELEMENT 02, yielding structures that are stored in the structure retainer, FIG. 1 ELEMENT 03. These structures are subsequently fit either to a classified token or to the acoustical transformational structures derived in association with a classified token by the fitting software, FIG. 1 ELEMENT 04.

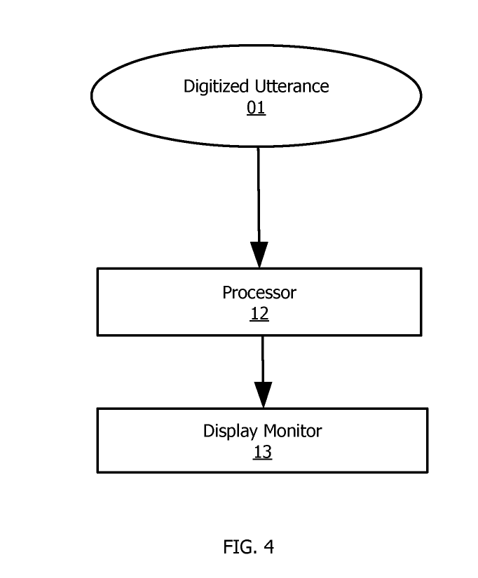

The hardware architecture of the invention is depicted schematically in FIG. 4. The software elements function within a processor, FIG. 4 ELEMENT 12, and the results from any point in the sequences of steps depicted in FIG. 2 and FIG. 3 may be displayed on a display monitor, FIG. 4 ELEMENT 13.

The digitized utterance FIG. 1, ELEMENT 01, to be processed may be received by the processor FIG. 4, ELEMENT 12, in various ways. In one embodiment of the invention it is recorded and digitized using an external audio interface device and imported to the processor, ELEMENT 12, by USB cable. In another embodiment it is submitted by an electronic communication link. These and other methods for receiving a digitized utterance are familiar to persons of ordinary skill in the art. They may be accomplished using a general purpose computer and, if required, a general purpose audio interface and general purpose speech processing software.

In one embodiment, the invention employs commercially available acoustic transformational structure identifying software, FIG. 1 ELEMENT 02, that is based on U.S. Pat. No. 8,155,967, “Method and System to Identify, Quantify, and Display Acoustic Transformational Structures” to accomplish the identifying of acoustic transformational structures, FIG. 2 STEP 07 and FIG. 3 STEP 07. Another embodiment employs user-designed software built by persons skilled in the art to the specifications of U.S. Pat. No. 8,155,967.

In U.S. Pat. No. 8,155,967 acoustic transformational structures are identified by measuring periodic simultaneous changes in multiple acoustic features over the course of a selected digitized segment of an utterance. This is an excellent approach because the inherent function of such structures, which are properties of the person, is to manipulate all of the components of vocalized sound simultaneously in order to generate speech. Taking measurements of these components on a periodic basis ensures that repeated instances of structural activity will be captured according to a uniform temporal standard.

A third embodiment employs user designed acoustic tranformational identifying software to accomplish STEP 07 that is not based on U.S. Pat. No. 8,155,967. The embodiment of this type falls within the scope of the invention so long as this software identifies structures that have the essential property of performing operations on multiple phonological elements concurrently in the course of generating speech.

In one embodiment, the invention employs commercially available database software to retain the structures, FIG. 2 ELEMENT 08. These structures may be stored as numerical arrays, indexed in databases, or as images. There are a wide variety of appropriate commercial software programs available that are familiar to person skilled in the art.

In another embodiment the user designs a storage method appropriate to the user's needs. It may be, for example, that the user wishes to store the structures by assigning names to them, graphical locations, or in some other way, or wishes to create an original database template.

Obtaining a classified token of human behavior, FIG. 2 ELEMENT 06, may be accomplished by various means. In one embodiment, tokens may be classified using an assessment tool. In studies of an emotional state, cognitive style, or personality feature, for example, a researcher may administer a battery of tests to classify persons regarding the presence, absence, or degree of that state, style, or feature. In this embodiment, the associated digitized utterance, FIG. 2 ELEMENT 05, will be derived from a sample or samples of the person's speech.

In another embodiment, a token of human behavior is classified according to an ad hoc decision by the classifier. One may use the invention for studying the speech of a person one regards as “nice,” for example. While the scientific validity of the product of such an embodiment may be limited, this method nevertheless falls within the scope of the invention.

The digitized utterance, FIG. 2 ELEMENT 05 that is associated with a classified token of behavior, FIG. 2 ELEMENT 06, need not have the same source as the classified. One may wish to study speech that leads to violent behavior in others, for example, in which case the digitized utterance and the categorized token derive from different individuals.

In another embodiment, a token of human behavior may be classified by reference to a previously assigned classification. Examples may include persons who live in a specific geographical area, persons with a particular color hair, or persons who are a specific person.

The fitting software, FIG. 1 ELEMENT 04, used by the invention to determine best fit, FIG. 2 and FIG. 3, STEP 09, may employ a variety of strategies for determining best fit. The fitting process may involve single or multiple structures and single or multiple tokens of behavior.

In one embodiment, this step will be accomplished by using readily available statistical software familiar to a person of ordinary skill in the art. In fitting the retained acoustic transformational structures associated to a classified token or classified tokens of human behavior, FIG. 2 STEP 09, the instances of the behavior and the instances of the associated structures will be entered into an appropriate database and statistical estimates performed in a manner familiar to persons skilled in the art. In fitting retained acoustic transformational structures of a digitized utterance associated with an unclassified token of human behavior to the structures derived from an utterance associated with a classified token, FIG. 3 STEP 09, instances of each set of structures will be entered into an appropriate database and statistical comparisons executed.

Although embodiments of the invention that use statistical means to execute the fitting procedure may yield the most scientifially valid results, the fitting step indicated by FIG. 2 STEP 09 and FIG. 3. STEP 09, may be accomplished by non-scientific methods, however fanciful, and still fall within the scope of the invention. To fall within the scope of the invention it need only be that a particular embodiment supply a fitting procedure for accomplishing STEP 09 in a manner useful to the user of that embodiment.

In another embodiment, for example, a user may find it useful to accomplish STEP 09 by drawing intuitive conclusions regarding fit that are based on the appearance of visual images of the retained acoustic transformational structures, FIG. 2 and FIG. 3 ELEMENT 08.

Following is an example that illustrates the utility of the invention:

Fifteen subjects were administered a personality test and scored for several characteristics. Independently, acoustic transformational structures were identified in 20 second speech samples of the subjects using an acoustic transformational structure identifier. Pearson correlation coefficients, r, were calculated for the scores of each characteristic and several combinations of structures. The highest correlation, r=0.77, was between the characteristic of “conscientiousness” and an adjusted measure of specific acoustic transformational structures. The invention could later be used to indentify the changing level of conscientiousness in one subject who was treated successfully for mental illness, and for confirming that conscientiousness increased.

What is claimed is:

1. A computer implemented method to identify the acoustic profile of a classified token of human behavior, the method comprising:
a) selecting a token of human behavior that is classified as containing or representing at least one human characteristic,
b) selecting an utterance associated with the classified token,
c) using an acoustic transformational structure identifying method to identify and measure one or more acoustic transformational structures contained in the selected utterance, and
d) determining the best fit between the classified token and the one or more identified acoustic transformational structures.

2. The method of claim 1, wherein an unclassified token of human behavior is classified using speech acoustics, the computer implemented method further comprising:
a) selecting an unclassified token of human behavior,
b) selecting an utterance associated with the unclassified token,
c) using an acoustic transformational structure identifying method to identify one or more acoustic transformational structures contained in the selected utterance, and
d) determining the best fit between the one or more acoustic transformational structures contained in the selected utterance and the one or more acoustic transformational structures previously shown to fit a classified token.

3. A computer implemented system to identify the acoustic profile of a classified token of human behavior, the method comprising:
a) selecting a token of human behavior that is classified as containing or representing at least one human characteristic,
b) selecting an utterance associated with the classified token,
c) using an acoustic transformational structure identifying system to identify one or more acoustic transformational structures contained in the selected utterance, and
d) determining the best fit between the classified token and the one or more identified acoustic transformational structures.

4. The system of claim 3, wherein an unclassified token of human behavior is classified using speech acoustics, the computer implemented system further comprising:
a) selecting an unclassified token of human behavior,
b) selecting an utterance associated with the unclassified token,
c) using an acoustic transformational structure identifying system to identify one or more acoustic transformational structures contained in the selected utterance, and
d) determining the best fit between the one or more acoustic transformational structures contained in the unclassified token and one or more acoustic transformational structures previously shown to fit a classified token.

5. A non-transitory computer readable medium having stored therein computer readable instructions which when executed cause a computer to perform a set of operations for identifying the acoustic profile of a classified token of human behavior, the set of operations comprising:
a) selecting a token of human behavior that is classified as representative of at least one human characteristic,
b) selecting an utterance associated with the classified token,
c) using an acoustic transformational structure identifying computer readable medium to identify and measure one or more acoustic transformational structures contained in the selected utterance, and
d) determining the best fit between the classified token and the one or more identified acoustic transformational structures.

6. The non-transitory computer readable medium of claim 5, wherein an unclassified token of human behavior is classified using speech acoustics, the computer readable instructions further comprising:
a) selecting an unclassified token of human behavior,
b) selecting an utterance associated with the unclassified token,
c) using an acoustic transformational structure identifying computer readable medium to identify one or more acoustic transformational structures contained in the selected utterance, and
d) determining the best fit between the one or more acoustic transformational structures contained in the unclassified token and one or more acoustic transformational structures previously shown to fit a classified token.
